(19) United States
(12) Patent Application Publication
(10) Pub. No.: US 2024/0123777 A1
(43) Pub. Date: Apr. 18, 2024

(54) A DEVICE TO ACCEPT A PRESSURISED FLUID

(71) Applicant: Stewart Thompson, Strathmore (AU)

(72) Inventor: Stewart Thompson, Strathmore (AU)

(21) Appl. No.: 18/277,810

(22) PCT Filed: Feb. 21, 2022
(86) PCT No.: PCT/AU2022/050123

§ 371 Date: Aug. 18, 2023

(30) Foreign Application Priority Data
Feb. 19, 2021 (AU) 2021900436

(51) Int. Cl. B60C 23/16; F17C 13/08

(52) U.S. Cl. CPC B60C 23/16; F17C 13/084; F17C 2201/0119; F17C 2201/0152; F17C 2201/0166; F17C 2201/0171; F17C 2203/012; F17C 2203/0646; F17C 2203/066; F17C 2205/0311; F17C 2209/2181; F17C 2209/219; F17C 2221/031; F17C 2223/036

(57) ABSTRACT

A storage tank for storing compressed fluid supplied from a source, comprising: an single piece elongate extruded body having an upper surface, a lower surface and side walls connecting the upper surface and the lower surface and at least one support member extending between the upper surface and the lower surface to define a plurality of storage chambers within the elongate body; and a pair of end caps mounted to an end of the elongate body to provide communication between the plurality of storage chambers, each end cap having a plurality of sockets formed thereon, at least one of which is connectable to the source for receiving the compressed fluid for storage within the plurality of storage chambers.

### RELATED APPLICATIONS

The present application claims priority from Australian Provisional Patent Application No. 2021900436 filed on 19 Feb. 2021, the entire contents of which are incorporated herein by reference.

### FIELD OF INVENTION

The present invention relates generally to a storage tank for storing compressed air, and in particular, to a storage tank for mounting in a vehicle that is formed in a flat and rigid manner for use in a variety of applications.

### BACKGROUND OF THE INVENTION

Storage tanks for storing compressed air are a useful tool for providing access to a ready supply of compressed air in a variety of different situations. Such storage tanks are able to be filled with a volume of compressed air/gas that can then be stored under pressure, for immediate use. In some applications, the storage tanks may be fluidly connected to a component containing compressed air, such that should that component be required to release a quantity of the compressed air contained therein, the compressed air can be released into the storage tank for capture and later re-supply, should the component require it.

A common application for such storage tanks is in vehicles where the tyre pressure within a tyre requires adjustment, depending upon the driving conditions for the vehicle. Often, where vehicles such as 4WD or agricultural vehicles are required to be used in both off-road and on-road situations, there is a need to provide a system for rapidly changing the tyre pressure as the vehicle moves between a non-road environment and a road environment.

Typically, in off-road conditions, such as muddy tracks, sand, rocky roads and the like, it is recommended to reduce the air pressure in the tyres in order to improve the traction of the vehicle as well as the ride comfort of the passengers in the vehicle. A lower tyre pressure increases the footprint of the tyre resulting in more rubber being present on the ground and thus greater traction. Whilst such a tyre pressure situation is preferable in off-road conditions, in on-road conditions low tyre pressure can have a significant negative effect on the roll efficiency of the tyres and the speed and fuel efficiency of the vehicle and can generate heat in the tyre which can destroy the integrity of the tyre. Thus, it is necessary to increase the tyre pressure upon entering a paved road surface.

To manually inflate and deflate a tyre upon changing road conditions can take considerable time which is highly undesirable. For this reason, automated systems has been proposed to automatically and rapidly inflate and deflate a tyre as desired. Such systems typically incorporate a compressor to generate a supply of compressed air as well as one or more storage tanks to store the compressed air as it is bled from the tyres. The storage tanks are able to store the compressed air and release the compressed air back into the tyres as required to reduce the time required to inflate the tyres. By having such a ready supply of compressed air in contact with the tyres, the tyres can be quickly and efficiently inflated to a desired pressure.

There are a variety of other needs to provide a system for storing and releasing compressed air in a vehicle. Many vehicles employ air suspension systems which require constant inflation and deflation of the air suspension system to raise and/or lower the vehicle. Such systems also employ storage tanks to capture the released compressed air from the system for later reuse.

Whilst such systems have proven effective in providing such a ready supply of compressed air, conventional storage tanks have proven difficult to incorporate into a vehicle in a space saving manner. In order to have sufficient structural strength and integrity, such tanks are typically round in configuration and configured to have a desired pressure rating to store such a volume of compressed air in a safe and controlled manner. With round storage tanks, such vessels require dedicated brackets and the like to mount them in position on the vehicle and cannot be simply adapted to be fitted in compact areas of the body of the vehicle, such as in wall cavities and under the vehicle. Further to this, round storage tanks cannot be simply stacked or arranged in banks in a space efficient manner, as any multiple storage tank system will require significant storage space, which is often not possible on most commercial vehicles.

Thus, there is a need to provide a storage tank for a vehicle that has sufficient strength to store compressed air at a desired level of compression and which can be mounted to a vehicle in a manner that minimises the space requirements of the vehicle to accommodate such a storage tank.

The above references to and descriptions of prior proposals or products are not intended to be, and are not to be construed as, statements or admissions of common general knowledge in the art. In particular, the above prior art discussion does not relate to what is commonly or well known by the person skilled in the art, but assists in the understanding of the inventive step of the present invention of which the identification of pertinent prior art proposals is but one part.

### STATEMENT OF INVENTION

The invention according to one or more aspects is as defined in the independent claims. Some optional and/or preferred features of the invention are defined in the dependent claims.

Accordingly, in one aspect of the invention there is provided a storage tank for storing compressed fluid supplied from a source, comprising:
an elongate body having an upper surface, a lower surface and side walls connecting the upper surface and the lower surface;
at least one support member extending between the upper surface and the lower surface to define a plurality of storage chambers within the elongate body; and
a pair of end caps mounted to an end of the elongate body, each end cap having a plurality of sockets formed thereon, at least one of which is connectable to the source for receiving the compressed fluid for storage within the plurality of storage chambers.

In one embodiment, the upper surface and lower surface of the elongate body are substantially flat. The elongate body may have a substantially stadium shaped end profile.

The at least one support member may have an X-shaped cross section and connects to the upper surface and the lower surface of the elongate body at two points.

The storage chambers may have a substantially circular cross section.

The elongate body may be formed by an extrusion process. The elongated body may be extruded from a metal. The metal may be aluminium.

In another embodiment, the elongated body may be extruded from a plastic material.

In another embodiment, the tank is formed from a composite material.

The fluid may be a compressed gas, such as air, hydrogen or natural gas.

### BRIEF DESCRIPTION OF THE DRAWINGS

The invention may be better understood from the following non-limiting description of preferred embodiments, in which:

FIG. 1 is a perspective view of a storage tank in accordance with an embodiment of the present invention;

FIG. 2 is a top view of the storage tank of FIG. 1;

FIG. 3 is a side view of the storage tank of FIG. 1;

FIG. 4 is an exploded view of the storage tank of FIG. 1;

FIG. 5 is an enlarged view of the end of the exploded view of FIG. 4;

FIG. 6 is an isolated view of the body of the storage tank of FIG. 1;

FIG. 7 is an end profile of an alternative embodiment of the elongate body of the storage tank;

FIG. 8 is an end profile of another alternative embodiment of the elongate body of the storage tank; and

FIG. 9 is an end profile of yet another alternative embodiment of the elongate body of the storage tank.

### DETAILED DESCRIPTION OF THE DRAWINGS

Preferred features of the present invention will now be described with particular reference to the accompanying drawings. However, it is to be understood that the features illustrated in and described with reference to the drawings are not to be construed as limiting on the scope of the invention.

The present invention will be described below in relation to a storage tank for storing compressed air in a vehicle. Whilst the storage tank will be described below in relation to its application for storing compressed air in a conventional vehicle tyre inflation/deflation system, the present invention could be employed for storing compressed air in any type of system where a device is required to inflate/deflate, whether that system is vehicle related or not.

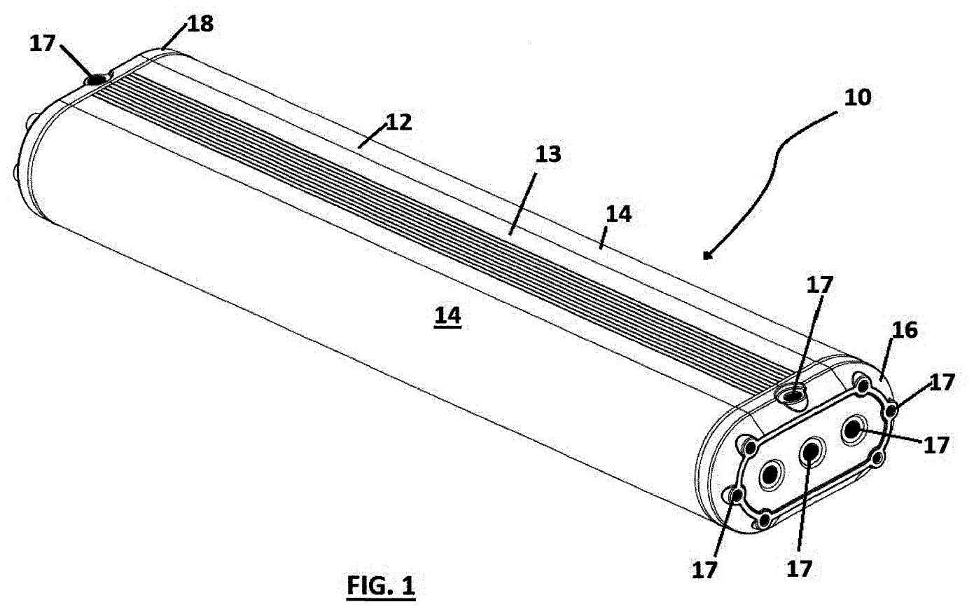

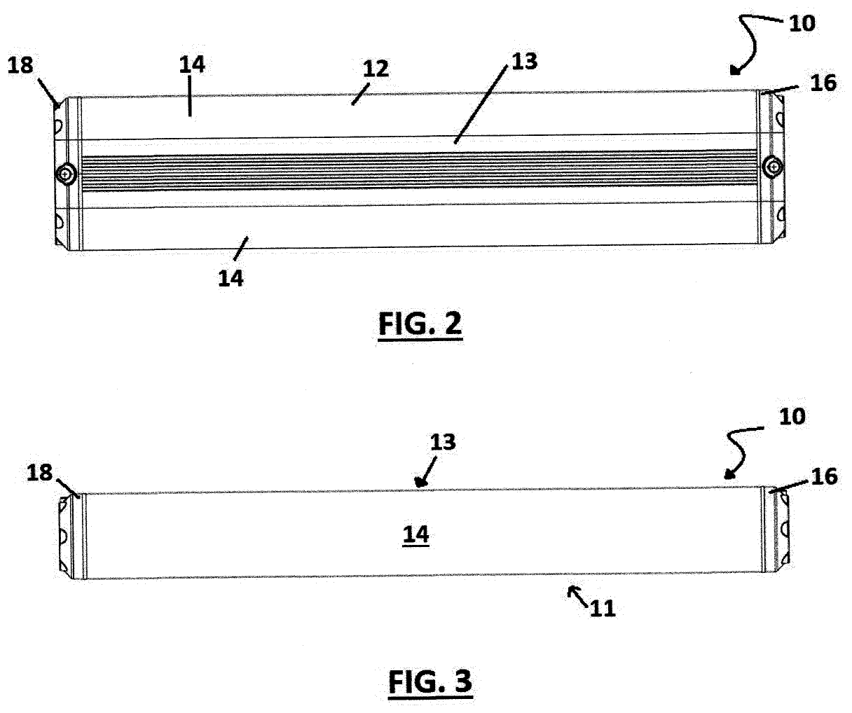

Referring to FIGS. 1-3 a storage tank 10 in accordance with a preferred embodiment of the present invention is shown. The storage tank 10 comprises a storage body 12 and two end caps 16, 18 which enclose the ends of the storage body 12.

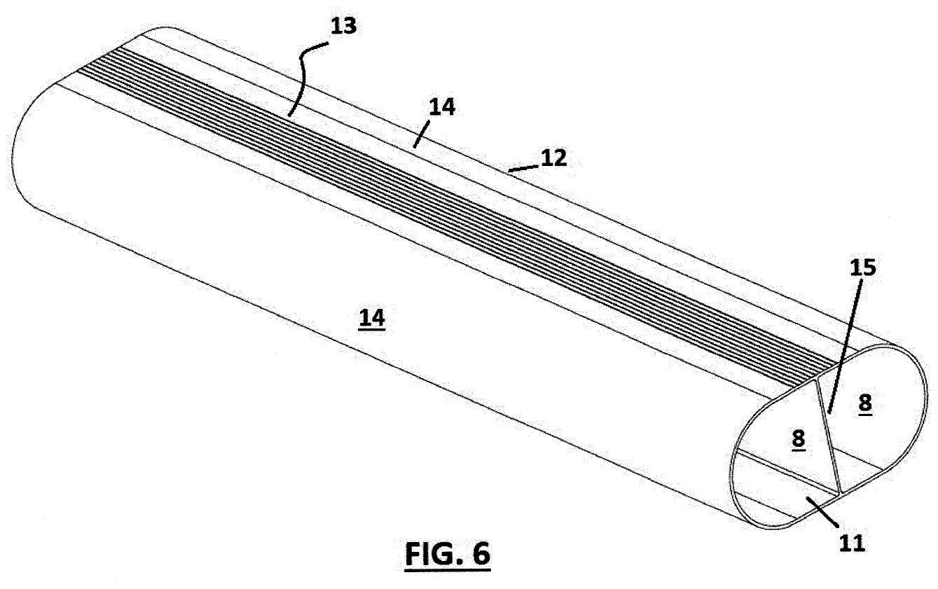

The storage body 12 is shown in isolation in FIG. 6. The storage body 12 is formed from a metal extrusion process, such as aluminium extrusion, to define an internal space having a discorectangle or stadium end profile. The body 12 is formed as a single integral piece and has a first wall 11 and a second wall 13 that are substantially flat to assist in mounting the tank 10 against a wall or surface of a vehicle, as will be described in more detail below. In the embodiment as shown, the first wall 11 forms a bottom surface of the body 12 and the second wall 13 forms an upper surface of the body 12. The first wall 11 and second wall 13 are connected at opposing ends by way of a curved or arc wall 14. The first wall 11, second wall 13 and curved or arc wall 14 are integrally formed during the extrusion process.

A support member 15, in the form of a thin wall member, extends longitudinally within the internal space, extending between an inner surface of the first wall 11 and an inner surface of the second wall 13. The support member 15 functions to provide additional strength to the body 12 and forms two storage chambers 8 within the internal space of the body 12. Whilst only one support member 15 is shown, multiple support members 15 may be provided to provide additional strength to the body 12 and form multiple storage chambers, as will be appreciated by those skilled in the art.

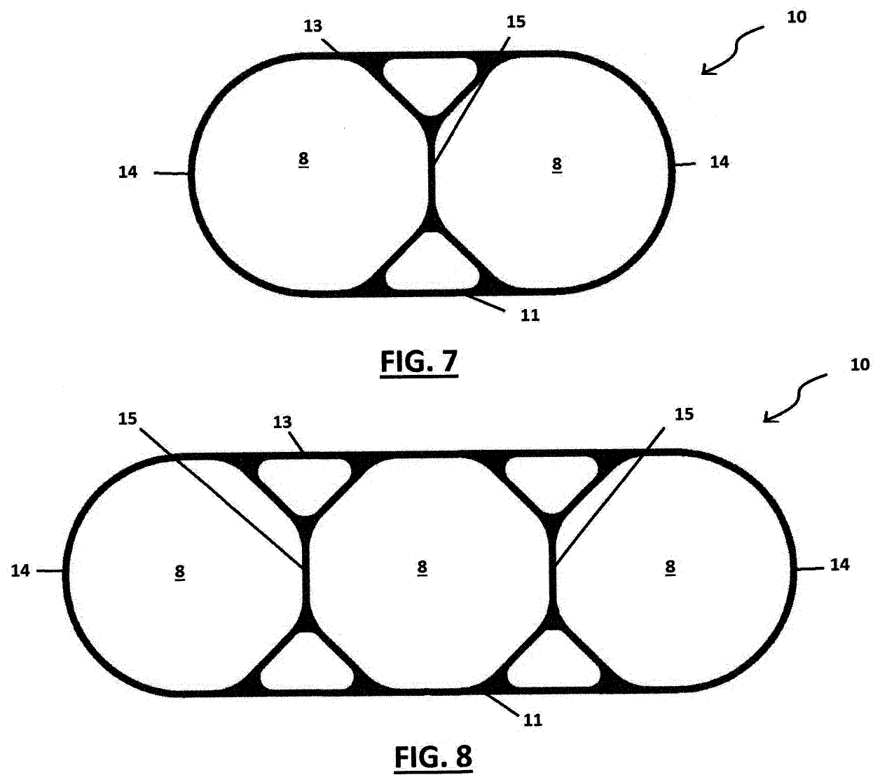

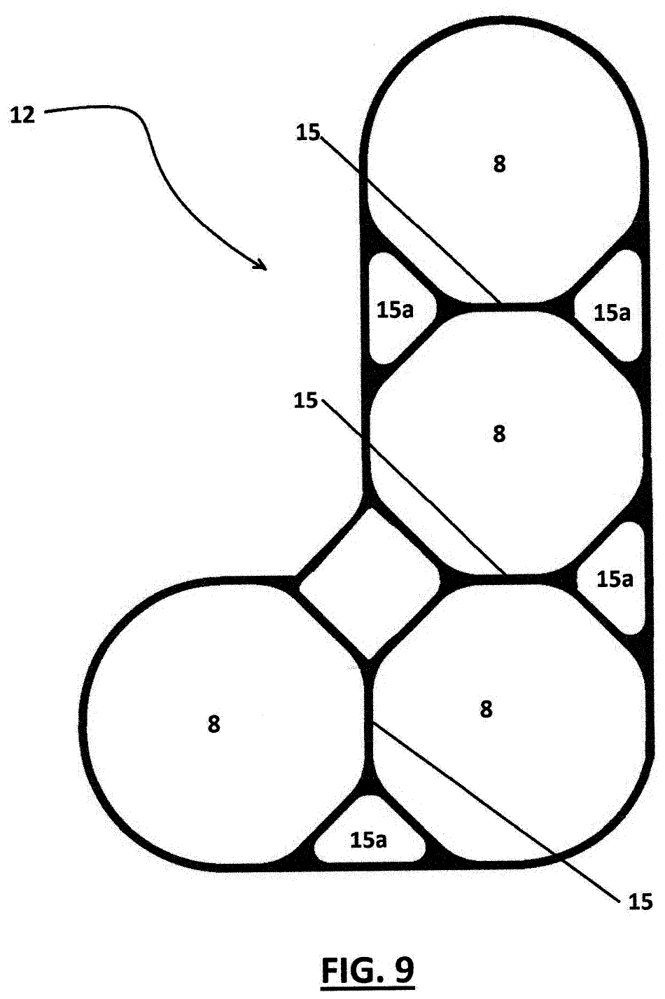

An alternative embodiment of the body 12 is depicted in FIG. 7 and FIG. 8. In this embodiment, the support member 15 is in the form of an expanded X-shaped member that extends between the first wall 11 and second wall 13 to define chambers 8 having a substantially circular cross section. The shape of the support members 15, namely with the upper and lower arms of the support member 15 diverging to meet with the first wall 11 and second wall 13 at two points, greatly increases the strength of the body 12 to withstand considerable internal pressure forces. The upper arms of the support member thereby form a triangular void 15a which further reinforces the integrity of the body. Due to the shape of the support member 15, the body 12 can be provided with multiple support members 15 extending across its width to form more than two chambers 8 for storing the compressed air. FIG. 8 shows an arrangement whereby two support members 15 are provided to form three storage chambers 8. However, multiple support members 15 may be provided to form any number of storage chambers 8, as will be required. An alternative embodiment of the body 12 is shown in FIG. 9. In this embodiment the body 12 is extruded to form an L-shaped body to enable the tank to be fitted into a similar shaped space in a vehicle or the like.

As the body 12 is formed from an extrusion process, the body is able to be manufactured in a single integral piece having an accurate form having high strength and low weight properties and in a manner that minimises material waste.

Such a simple and easy form of manufacturing the storage body 12 of the tank 10 enables the tank 10 to be manufactured in a consistent manner to any desired length and to any desired strength rating, by controlling the number of support members 15.

The end caps 16, 18 are formed from a forged metal, such as aluminium, and machined to provide a plurality of sockets 17 therein. The end caps 16, 18 are fitted to the end of the extruded body 12 and have a hollow shape such that they facilitate communication between chambers formed in the body 12. In this regard, one or more of the sockets 17 may be machined to provide an internal thread therein to enable the socket 17 to receive hardware, such as a valve associated with a hose or the like for fluidly connecting the tank 10 to a compressed air supply, such as a tyre, compressor or the like. Multiple sockets 17 are provided to accommodate multiple locations for attaching hardware thereto. The sockets 17 can also accommodate mounting brackets to facilitate mounting the tank 10 to a wall or surface of a vehicle.

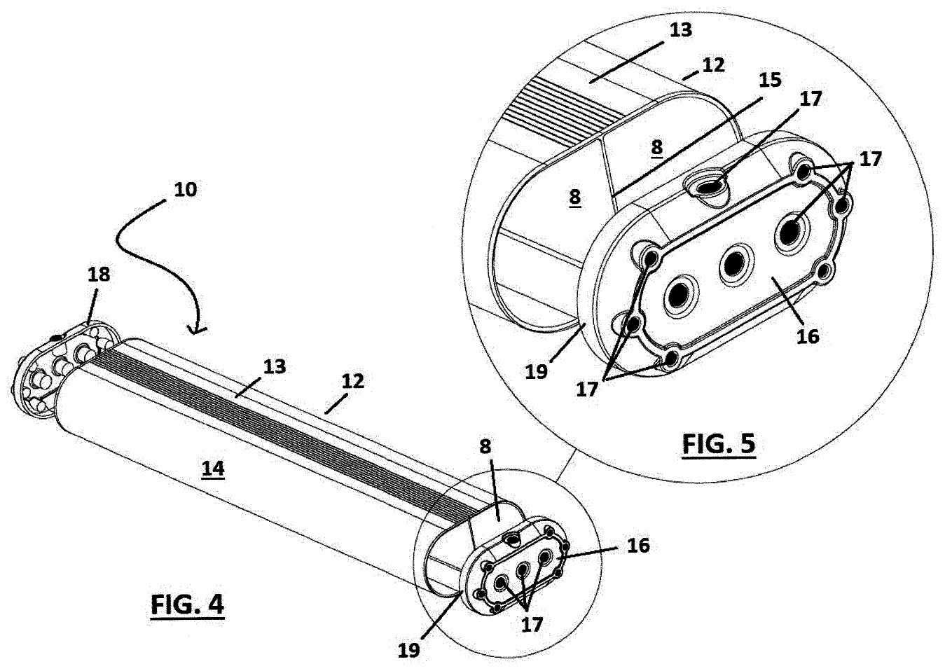

The end caps 16, 18 are preferably welded into position on the ends of the body 12. As is shown more clearly in FIG. 4 and FIG. 5, the end caps 16, 18 may include a flange portion 19 that projects into the internal space 8 of the body 12 to provide a seat against which the weld may be supported. The flange portion 19 may extend about an inner periphery of the end caps 16, 18 or may extend only partially about the periphery thereof. When fitted, the end caps 16, 18 form a sealed tank 10 into which the compressed air can be received and stored for later reuse. The individual chambers of the tank 10 are in communication via the end caps 16, 18 and as the body 12 of the tank 10 is a single piece extrusion, it exhibits high strength properties capable of storing air at high pressures as required.

In an alternative embodiment, the end caps 16, 18 may be attached to the ends of the body 12 by way of screws or similar fasteners configured to securely engage the end caps to the body in a sealed manner.

The completed tank 10 is substantially flat and is able to be mounted against any surface of a vehicle as required. In this regard, the tank 10 may be installed in areas of the vehicle that would not accommodate a conventional round tank, due to the greater height and diameter of such conventional round tanks. This is particularly important when the tank 10 is mounted under a vehicle as it is substantially flat and able to maintain a sufficient clearance under the vehicle, as required. Similarly, the tank 10 is substantially flat and of a length that enables it to be easily mounted within a wall space or cavity of a commercial/trade vehicle where other rounder tanks are not able to be mounted. This does not impinge on the carrying and/or storage capacity of the vehicle and ensures that the tanks can utilise space in a vehicle structure that is often not utilised.

The shape and configuration of the tank 10 also enables multiple tanks 10 to be employed in a stacked manner and linked together to provide greater air storage capacity. The tanks 10 can be simply mounted on top of each other with the flat surface of the tanks 10 ensuring that the stacked system is compact and maximises storage space.

The tank 10 may be made from a metal, such as aluminium, that is capable to withstand high pressure situations without deforming and rupturing. In another embodiment, the tank 10 may be formed from composite materials, such as plastics, synthetic fibres and the like. A variety of materials may also be used to form the end caps 16, 18 and body 12 of the tank 10, as will be appreciated by those skilled in the art.

It will be appreciated that the storage tank 10 of the present invention provides an alternative to conventional cylindrical tanks employed for this purpose. The body of the tank of the present invention is formed as a single piece extrusion that enables the tanks to be formed in variable lengths and with minimal wastage. The end caps are also formed from a forging process to ensure that the strength of the tank is maintained and that the tanks can be simply welded or screwed together to provide a substantially flat storage tank with enhanced strength characteristics.

To provide additional strength, the tank 10 may be wrapped in a composite material, such as carbon fibre to enable the tank to store a compressed gas at a greater pressure. By wrapping the tank with a carbon fibre material, the operating pressure of the tank can be increased to anywhere between 3000-10000 psi.

Throughout the specification and claims the word “comprise” and its derivatives are intended to have an inclusive rather than exclusive meaning unless the contrary is expressly stated or the context requires otherwise. That is, the word “comprise” and its derivatives will be taken to indicate the inclusion of not only the listed components, steps or features that it directly references, but also other components, steps or features not specifically listed, unless the contrary is expressly stated or the context requires otherwise.

Orientational terms used in the specification and claims such as vertical, horizontal, top, bottom, upper and lower are to be interpreted as relational and are based on the premise that the component, item, article, apparatus, device or instrument will usually be considered in a particular orientation, typically with the tank uppermost.

It will be appreciated by those skilled in the art that many modifications and variations may be made to the methods of the invention described herein without departing from the spirit and scope of the invention.

The claims defining the invention are as follows:

1. A storage tank for storing compressed fluid supplied from a source, comprising:
an single piece elongate extruded body having an upper surface, a lower surface and side walls connecting the upper surface and the lower surface and at least one support member extending between the upper surface and the lower surface to define a plurality of storage chambers within the elongate body; and
a pair of end caps mounted to an end of the elongate body to provide communication between the plurality of storage chambers, each end cap having a plurality of sockets formed thereon, at least one of which is connectable to the source for receiving the compressed fluid for storage within the plurality of storage chambers.

2. A storage tank according to claim 1, wherein the upper surface and lower surface are substantially flat.

3. A storage tank according to claim 2, wherein the elongate body has a substantially stadium shaped end profile.

4. A storage tank according to claim 1, wherein the at least one support member has an X-shaped cross section and connects to the upper surface and the lower surface of the elongate body at two points to form a triangular void with the upper surface and lower surface of the body.

5. A storage tank according to claim 1, wherein the storage chambers have a substantially circular cross section.

6. A storage tank according to claim 1, wherein the elongate body is formed by an extrusion process;

7. A storage tank according to claim 6, wherein the elongated body is extruded from a metal.

8. A storage tank according to claim 2, wherein the metal is aluminium.

9. A storage tank according to claim 6, wherein the elongated body is extruded from a plastic material.

10. A storage tank according to claim 1, wherein the tank is formed from a composite material.
